(19) United States
(12) Patent Application Publication
(10) Pub. No.: US 2025/0256270 A1
(43) Pub. Date: Aug. 14, 2025

(54) METHOD FOR PRODUCING METAL NANOWIRE CATALYST

(71) Applicant: HONDA MOTOR CO., LTD., TOKYO (JP)

(72) Inventors: Osamu USAKA, WAKO-SHI (JP); Hiroshi MATSUMORI, WAKO-SHI (JP)

(21) Appl. No.: 19/046,687

(22) Filed: Feb. 6, 2025

(30) Foreign Application Priority Data
Feb. 13, 2024 (JP) 2024-019678

(51) Int. Cl. B01J 35/45; B01J 23/42; B01J 37/06; B01J 37/16; B82Y 30/00; B82Y 40/00

(52) U.S. Cl. CPC B01J 35/45; B01J 23/42; B01J 37/06; B01J 37/16; B82Y 30/00; B82Y 40/00

(57) ABSTRACT

A method for producing a metal nanowire catalyst includes a supporting step of supporting metal nanowires on carbon supports and a washing step of removing impurities from supports obtained by supporting the metal nanowires on the carbon supports. The washing step includes a first mixing step of bringing a solution containing a hydride reducing agent into contact with the supports and a first separation step of removing first impurities separated from the supports, from a first mixture obtained in the first mixing step.

### CROSS-REFERENCE TO RELATED APPLICATIONS

This application is based upon and claims the benefit of priority from Japanese Patent Application No. 2024-019678 filed on Feb. 13, 2024, the contents of which are incorporated herein by reference.

### BACKGROUND OF THE INVENTION

### Field of the Invention

The present disclosure relates to a method for producing a metal nanowire catalyst.

### Description of the Related Art

Metal nanowires show promise as a catalyst material having excellent catalytic activity because of a large surface area to mass (specific surface area) and having excellent durability because of a relatively stable surface. The synthesis of the metal nanowires is performed by reducing a metallic salt in a solvent with a dispersant and a protective agent added thereto. As the metal nanowires, for example, synthetic examples of gold, silver, copper, platinum, nickel, and the like are known.

In “Synthesis and electrocatalytic activity for oxygen reduction reaction of Pt—Ni nanowires”, Yoshimi IGUCHI et al., Proceedings of Battery Symposium, PDF (CD-ROM), Vol. 61, ROMBUNNO. 3G02, published in 2020, there are descriptions of synthesis examples of metal nanowires made of platinum-nickel alloys and catalytic activities thereof.

### SUMMARY OF THE INVENTION

The metal nanowires synthesized as described above are mixed with a carbon support in a solvent and thereby supported on the carbon support to obtain a metal nanowire catalyst. A dispersant is used when the metal nanowires are supported on the carbon support. The dispersant is adsorbed on the surfaces of the metal nanowires to prevent the metal nanowires from aggregating in the solvent. However, if the metal nanowires are insufficiently washed, the surfaces of the metal nanowires are covered with impurities, resulting in a low catalytic activity.

In order to remove such impurities attached to the metal nanowires, the present inventors tried to perform washing using an organic solvent and water. However, it has been found that the impurities cannot be sufficiently removed by the usual washing, and the catalytic activity is not improved as expected.

Further, the inventors of the present application focused on the fact that an organic substance is used as the dispersant or the protective agent, and attempted to remove impurities by volatilization or oxidation (combustion) by heating the metal nanowire catalyst to a temperature of several hundred degrees Celsius. However, it has been found that when the metal nanowire catalyst is treated at a high temperature, sintering (aggregation due to sintering) occurs in the carbon support and the metal nanowire catalyst, the surface area decreases, and consequently the catalytic activity rather decreases.

It is an object of the present invention to solve the above problems.

An aspect of the present disclosure is characterized by a method for producing a metal nanowire catalyst, the method including: a supporting step of supporting a metal nanowire on a carbon support; and after the supporting step, a washing step of removing impurities from a support obtained by supporting the metal nanowire on the carbon support, wherein the washing step includes: a first mixing step of bringing a solution containing a hydride reducing agent into contact with the support; and a first separation step of removing a first impurity separated from the support in the first mixing step, from a first mixture obtained in the first mixing step.

According to the method for producing the metal nanowire catalyst, impurities attached to the metal nanowires can be removed while maintaining the shape of the metal nanowires, and thus the catalytic activity can be improved.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an explanatory view of a method for producing a metal nanowire catalyst;

FIG. 2 is an explanatory view of a synthesis step of synthesizing metal nanowires;

FIG. 3 is an explanatory view of a supporting step of supporting the metal nanowires on a carbon support;

FIG. 4 is an explanatory view of a washing step of a carbon support (support) supporting the metal nanowires;

FIG. 5 is a graph showing results of measuring weight change of a metal nanowire catalyst (Comparative Example 1) not subjected to the washing step of FIG. 4 and a metal nanowire catalyst (Example) subjected to the washing step of FIG. 4, by thermo-gravimetry (thermobalance method);

FIG. 6A is a transmission electron microscope image of the metal nanowire catalyst of Comparative Example 1;

FIG. 6B is a transmission electron microscope image of a metal nanowire catalyst of Comparative Example 2 subjected to a heat treatment at 450° C.;

FIG. 6C is a transmission electron microscope image of the metal nanowire catalyst of Example subjected to washing with a washing liquid containing sodium borohydride;

FIG. 7 is a table showing results of measurement of a surface atomic concentration of the metal nanowire catalysts according to Comparative Example 1, Comparative Example 2, and Example by X-ray photoelectron spectroscopy (XPS); and

FIG. 8 is a graph showing results of measuring the activity-to-mass ratios of the metal nanowire catalysts according to Comparative Example 1, Comparative Example 2, and Example by a rotating disc electrode method (RDE).

### DETAILED DESCRIPTION OF THE INVENTION

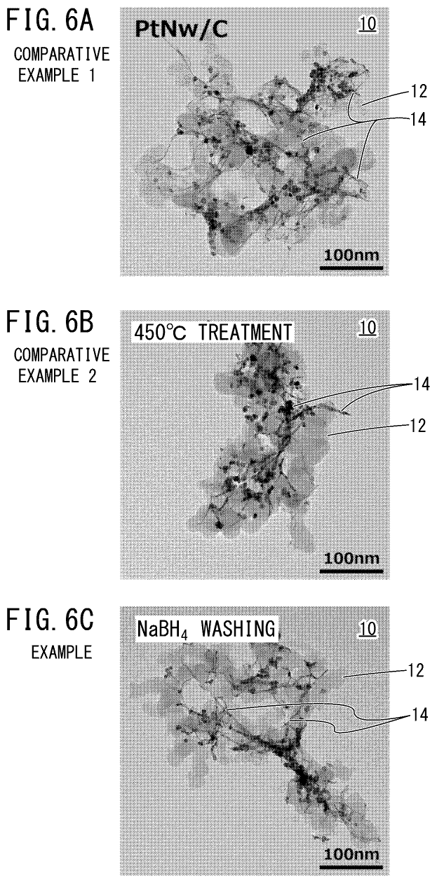

As shown in FIGS. 6A to 6C, metal nanowire catalysts 10 have a structure in which metal nanowires 14 formed into short fibers are dispersed and supported on surfaces of granular fine carbon supports 12 (carbon particles). Such metal nanowire catalysts 10 are used for an electrode of an electrochemical cell such as a fuel cell or a water electrolysis device.

The carbon support 12 is not particularly limited as long as it can support the metal nanowires 14. For example, CA250 (trade name) manufactured by Denka Company Limited, OSAB (trade name) manufactured by Denka Company Limited, Vulcan (trade name) manufactured by Cabot Corporation, Ketjenblack (registered trademark) manufactured by Ketjen Black International Company, Norit (trade name) manufactured by Norit, Black Pearls manufactured by Cabot Corporation, Acetylene Black (trade name) manufactured by Chevron, and VGCF (registered trademark) manufactured by Resonac Corporation can be used as the carbon support 12. The carbon support 12 is not limited to a granular shape, and may be a one dimensional shape or a two dimensional shape such as a carbon nanotube, a carbon nanohorn, a carbon nanowall, or a carbon nanofiber.

The carbon supports 12 are dispersed in a solvent in a particulate form in a supporting step described later. The carbon supports 12 may form aggregates each formed by aggregation of a plurality of particles, in the solvent.

The metal element constituting the metal nanowires 14 may be appropriately selected from any metal elements depending on the purpose. The metal element may be a base metal element such as nickel (Ni), copper (Cu), iron (Fe), cobalt (Co), tin (Sn), aluminum (Al), zinc (Zn), titanium (Ti), niobium (Nb), tungsten (W), molybdenum (Mo), chromium (Cr), or vanadium (V). The metal element may be a noble metal element such as platinum (Pt), silver (Ag), gold (Au), palladium (Pd), rhodium (Rh), iridium (Ir), ruthenium (Ru), or osmium (Os). The above-mentioned elements may be used alone or in combination with other elements, or the metal nanowires 14 may be formed of a plurality of the above-mentioned elements. The metal nanowires 14 may be made of an alloy in which some of the above-described elements are combined. The metal nanowires 14 made of platinum or a platinum alloy are suitable for the electrode catalyst of the fuel cell.

In general, the metal nanowires 14 have diameters of about 1 nm to 10 nm. The lengths of the metal nanowires 14 vary depending on the type of material and the manufacturing method, but are generally about several 100 nm to several μm. The metal nanowires 14 have a long and thin wire shape because the total length thereof is longer than the diameter thereof. The metal nanowires 14 may be used in the metal nanowire catalyst 10 in a state of being shortened to a shorter length than immediately after the synthesis, for example.

In one embodiment, the metal nanowires 14 may be intentionally shortened to a length that can be supported on the carbon support 12. When the average length of the metal nanowires 14 in the metal nanowire catalyst 10 is equal to or less than the particle diameter of the carbon support 12 or the diameter of an aggregate (secondary particle) thereof, the dispersibility is improved, and the metal nanowires 14 can be suitably supported on the carbon support 12. When the length of the metal nanowires 14 immediately after the synthesis is sufficiently short, the shortening step of shortening the fibers is not necessary.

The metal nanowire catalyst 10 of the present embodiment is produced by the following method.

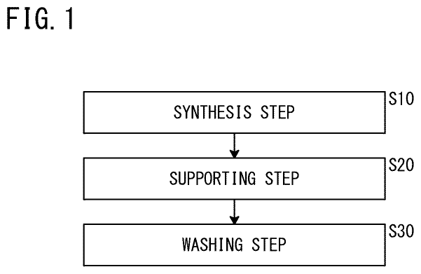

As shown in FIG. 1, the method for producing the metal nanowire catalyst 10 of the present embodiment includes a synthesis step (S10), a supporting step (S20), and a washing step (S30) in this order.

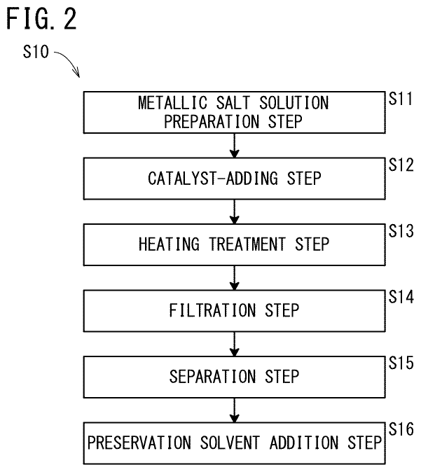

The method for producing the metal nanowire catalyst 10 starts with the synthesis step (S10). The synthesis step (S10) is a step of synthesizing the metal nanowires 14, and includes the steps shown in FIG. 2. The synthesis step (S10) begins with a preparation step of preparing a metallic salt solution (metallic salt solution preparation step) (S11). The preparation step of preparing the metallic salt solution (S11) includes a step of mixing a metallic salt as a precursor, glucose, octadecene, and oleylamine.

As the precursor used in the preparation step of preparing the metallic salt solution (S11), salts of the metal elements described above are used. The precursor is selected from substances which are reduced to a metal by reaction with the mixture in the synthesis step described below. For example, when platinum nanowires are synthesized, platinum (II) acetylacetonate can be used as the precursor. Octadecene is a solvent. Other solvents may be used in place of octadecene.

Oleylamine functions as a reducing agent and a stabilizing agent in the subsequent steps. That is, oleylamine serves as an electron donor at a high temperature, and reduces the metallic salt of the precursor to deposit the metal. Further, oleylamine suppresses the growth of the metal particles by covering the surfaces of the deposited metal particles, and the particle growth is limited to a nano-size, so that a larger amount of metallic salt is allowed to be used for the growth of the metal nanowires 14.

Glucose also functions as a reducing agent for the precursor. Instead of glucose, polyol can also be used. The polyol may be hexadecanediol, tetraethylene glycol, propylene glycol, trimethylene glycol, diethylene glycol, ethylene glycol or stearyl glycol.

In the preparation step of preparing the metallic salt solution (S11), the mixture is mixed with a stirrer or the like, and then further uniformly dispersed with an ultrasonic homogenizer or the like.

Next, the synthesis step (S10) proceeds to a catalyst-adding step (S12) of adding a protective agent and a catalyst. The protective agent is, for example, polyvinylpyrrolidone (PVP). Polyvinylpyrrolidone has a plurality of carbonyl groups (C═O bonding groups) in the molecule. The carbonyl group of polyvinylpyrrolidone is adsorbed to the deposited metal, and thus the polyvinylpyrrolidone molecules extending in a chain form surround the periphery of the deposited metal. This prevents the metal from growing in a spherical shape, and the deposited metal grows in a one dimensional shape (wire shape). The catalyst is added to promote the growth of the metal nanowires 14. The catalyst may be, for example, a tungsten (W) complex, a chromium (Cr) complex, or a molybdenum (Mo) complex. Hexacarbonyl tungsten may be suitably used in synthesizing platinum nanowires.

Next, the synthesis step (S10) proceeds to a heating treatment step (S13). In the heating treatment step (S13), the mixed solution prepared in the catalyst-adding step (S12) is heated to a predetermined reaction temperature (for example, 110° C. to 140° C.) to grow the metal nanowires 14. The heating treatment step (S13) is performed for several tens of minutes to several tens of hours. The heating treatment step (S13) includes a temperature raising step of heating from room temperature to a predetermined temperature and a cooling step of cooling from the predetermined temperature to room temperature. The temperature ramp-up step and the cooling step are performed at a predetermined temperature ramp-up rate or a predetermined temperature ramp-down rate. The heat treatment step may be performed while the mixed solution is being stirred.

Next, the synthesis step (S10) proceeds to a filtration step (S14). In the filtration step (S14), the metal nanowires 14 are extracted from the mixed solution by a method such as filtration.

Next, the synthesis step (S10) proceeds to a separation step (S15). In the separation step (S15), a washing solvent is added to the metal nanowires 14 collected by the filtration. The washing solvent may be, for example, a mixture of acetone, cyclohexane, and ethanol. By the addition of the washing solvent, a part of the impurities attached to the metal nanowires 14 is removed. The washing solvent and the metal nanowires 14 are mixed by stirring and ultrasonic wave application.

Next, in the separation step (S15), centrifugal separation is performed to separate the mixture containing the washing solvent and the metal nanowires 14 into a precipitate layer and a supernatant layer. The precipitate layer contains the metal nanowires 14, and the supernatant layer is formed of the washing solvent. Thereafter, the supernatant layer is removed, and the metal nanowires 14 are collected as the precipitate layer.

Thereafter, the separation step (S15) may be repeated a plurality of times by further adding a washing solvent to the collected precipitate layer and performing centrifugation.

The metal nanowires 14 obtained in the separation step (S15) are in a state of being surrounded by impurities containing polyvinylpyrrolidone and oleylamine. The impurities surrounding the plurality of metal nanowires 14 are likely to cause hydrophobic bonding due to interaction between non-polar groups. Therefore, when the metal nanowires 14 are dried, the aggregation of the metal nanowires 14 progresses, and it becomes difficult to disperse the metal nanowires 14 onto the carbon supports 12. Therefore, after the separation step (S15), a preservation solvent addition step (S16) is performed in which a preservation solvent is added to the metal nanowires 14. As the preservation solvent, for example, ethanol (alcohol) can be used. In the preservation solvent addition step (S16), a treatment of dispersing the metal nanowires 14 in the preservation solvent may be performed by applying ultrasonic waves. The preservation solvent addition step (S16) provides a metal nanowire dispersion liquid in which the metal nanowires 14 are dispersed in the preservation solvent.

Thus, the synthesis step (S10) is completed. The metal nanowires 14 synthesized in the synthesis step (S10) are used in the supporting step (S20) as a metal nanowire dispersion liquid.

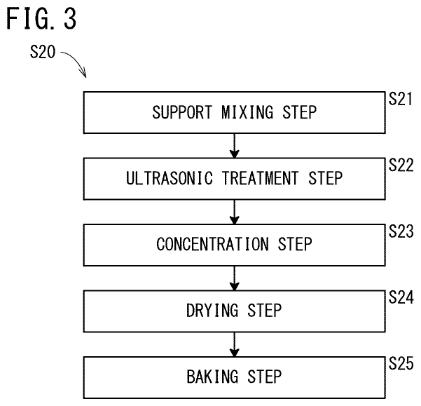

Next, the method for producing the metal nanowire catalyst 10 proceeds to the supporting step (S20). As shown in FIG. 3, the supporting step (S20) proceeds to a support mixing step (S21) of mixing the carbon supports 12 and the metal nanowires 14. In the support mixing step (S21), the carbon supports 12, the metal nanowire dispersion liquid, and a dispersion solvent are mixed. As the dispersion solvent, a solvent obtained by mixing a polar solvent and a non-polar solvent is used. For example, an organic solvent obtained by mixing ethanol and cyclohexane can be used as the dispersion solvent. In the support mixing step (S21), oleylamine may be further added as a dispersant. Oleylamine can efficiently disperse the metal nanowires 14 aggregated in a bundle by polyvinylpyrrolidone, in the solvent.

Next, the supporting step (S20) proceeds to an ultrasonic treatment step (S22). In the ultrasonic treatment step (S22), ultrasonic waves are applied to the mixed liquid prepared in the support mixing step (S21), by an ultrasonic homogenizer. The ultrasonic treatment step (S22) is performed, for example, for several tens of minutes to several hours. The ultrasonic treatment step (S22) separates the metal nanowires 14 aggregated in a bundle, and the separated metal nanowires 14 are treated into short fibers. The length of the metal nanowires 14 has a value corresponding to the frequency and output of the applied ultrasonic waves. The metal nanowires 14 that have been shortened into short fibers are attached to the surfaces of the carbon supports 12 in a dispersed state, and supports in which the metal nanowires 14 are supported on the carbon supports 12 are obtained.

Next, the supporting step (S20) proceeds to a concentration step (S23). In the concentration step (S23), the mixed liquid subjected to the ultrasonic treatment step (S22) is separated into a precipitate layer containing the supports and a supernatant layer containing the dispersion solvent, by centrifugation. In the concentration step (S23), the supernatant layer is removed, and the precipitate layer in which the supports are concentrated is collected.

Next, the supporting step (S20) proceeds to a drying step (S24). In the drying step (S24), the precipitate layer (suspending solution) obtained in the concentration step (S23) is dried. The drying step (S24) is performed by, for example, reduced-pressure drying. In the drying step (S24), the solvent is removed from the supports, and solid supports are obtained.

Thereafter, the supporting step (S20) proceeds to a baking step (S25). The baking step (S25) is performed by heating the supports to a baking temperature of 200° C. to 300° C. under an inert gas atmosphere containing, for example, about 3% of hydrogen gas. The baking temperature of the baking step (S25) is preferably set to, for example, about 250° C., because removing of the impurities attached to the surfaces of the metal nanowires 14 is promoted, but shrinkage due to sintering is not promoted.

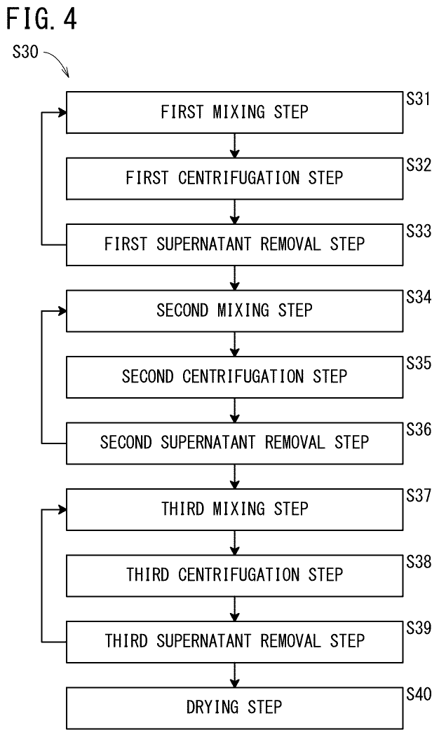

Next, the method for producing the metal nanowire catalyst 10 proceeds to a washing step (S30). As shown in FIG. 4, the washing step (S30) includes the steps shown. The washing step (S30) starts with a first mixing step (S31). The first mixing step (S31) includes a step of mixing the supports and a first washing liquid to obtain a first mixture. First impurities are separated from the supports in the first mixing step (S31). The first washing liquid is a solution containing a hydride reducing agent and a solvent. The solvent used in the first washing liquid contains, for example, alcohol and water.

The hydride reducing agent used in the first washing liquid hydrogenates the carbon double bond of the organic material remaining on the metal nanowire supports. The hydride reducing agent reduces carbonyl compounds such as ketone and aldehyde in organic substances to alcohol. The hydride reducing agent chemically changes the organic substances to lower the adsorbability of the organic substances to the metal nanowires 14. The hydride reducing agent chemically changes organic substances as impurities to improve the affinity for the solvent.

As the hydride reducing agent, at least one of sodium borohydride, lithium aluminum hydride, lithium borohydride, borane, sodium cyanoborohydride, and sodium triacetoxyborohydride can be used. Sodium borohydride can be handled safely and is suitable in terms of handling. However, the washing effect of the hydride reducing agent is not limited to sodium borohydride.

In the first mixing step (S31), oleylamine, polyvinylpyrrolidone, and the like used in the supporting step are considered to attach as impurities to the surfaces of the metal nanowires 14. Oleylamine receives a hydride ion from the hydride reducing agent and becomes octadecylamine. For example, when sodium borohydride is used as the hydride reducing agent, oleylamine and sodium borohydride react as follows. C₁₈H₃₇N+NaBH₄→C₁₈H₃₇NH₂+NaBO₂+H₂ (Reaction Formula 1) C₁₈H₃₇N+2NaBH₄→C₁₈H₃₇NH₂+2NaB(OH)₂+H₂ (Reaction Formula 2)

A part of sodium borohydride also reacts with water to generate sodium tetrahydroborate and hydrogen (Reaction Formula 2). The reaction as described above is an example of a reaction called reductive amination utilizing the reducing power of the hydride reducing agent. This reaction converts unsaturated functional groups such as carbonyl compounds and imine into amine.

The first washing liquid is prepared in advance prior to the first mixing step (S31). Since decomposition of the hydride reducing agent proceeds also by water, the first washing liquid is preferably prepared immediately before the first mixing step (S31).

Next, the washing step (S30) proceeds to a first centrifugation step (S32). In the first centrifugation step, the first mixture obtained in the first mixing step (S31) is centrifuged. In the first centrifugation step (S32), the first mixture is separated into a first precipitate layer containing the supports and a first supernatant layer containing impurities separated from the supports.

Next, the washing step (S30) proceeds to a first supernatant removal step (S33). In the first supernatant removal step (S33), the first supernatant layer separated in the first centrifugation step (S32) is removed. Thus, the first precipitate layer containing the supports is collected.

If necessary, the process may return to the first mixing step (S31), and the steps from the first mixing step (S31) to the first supernatant removal step (S33) may be repeatedly performed on the first precipitate layer.

Thereafter, the washing step (S30) proceeds to a second mixing step (S34). In the second mixing step (S34), the first precipitate layer and a second washing liquid are mixed to prepare a second mixture. Pure water (ion-exchanged water) is used as the second washing liquid. Second impurities composed of ionic substances are removed from the supports by the second washing liquid. Examples of the second impurities include calcium ion, magnesium ion, sodium ion, potassium ion, chloride ion, hydrogen carbonate ion, sulfate ion, and nitrate ion. In the present embodiment, the second mixing step (S34) is also effective for removing nitrate ions derived from oxidation of oleylamine.

Next, the washing step (S30) proceeds to a second centrifugation step (S35). In the second centrifugation step (S35), the second mixture obtained in the second mixing step (S34) is centrifuged. The second mixture is separated into a second precipitate layer containing the supports and a second supernatant layer containing the second impurities separated from the supports, by the second centrifugation step (S35).

Next, the washing step (S30) proceeds to a second supernatant removal step (S36). In the second supernatant removal step (S36), the second supernatant layer is removed, and the second precipitate layer is collected.

If necessary, the second mixing step (S34) to the second supernatant removal step (S36) may be performed once or repeatedly performed a plurality of times.

Thereafter, the washing step (S30) proceeds to a third mixing step (S37). In the third mixing step (S37), a third mixture is prepared by mixing the second precipitate layer with a third washing liquid. The third washing liquid is an organic solvent, and for example, a polar solvent can be used. As the third washing liquid, for example, any one of acetone, methanol, ethanol, acetic acid, ethyl acetate, chloroform, toluene, xylene, and methyl ethyl ketone, or a mixture thereof can be used. Further, when acetone, which is a polar solvent having a high affinity for water, is used as the third washing liquid, not only fat-soluble impurities but also water-soluble impurities can be removed, which is preferable.

The third impurities are removed from the supports by the third mixing step (S37). The third impurities are, for example, fat, oil, wax, resin, rubber, polymer, and the like. The third impurities may include the protective agent used in the synthesis step (S10), the dispersant used in the supporting step (S20), and the like.

Next, the washing step (S30) proceeds to a third centrifugation step (S38). The third mixture is separated into a third supernatant layer and a third precipitate layer by the third centrifugation step (S38).

Next, the washing step (S30) proceeds to a third supernatant removal step (S39). In the third supernatant removal step (S39), the third supernatant layer is removed. The supports are collected together with the third precipitate layer.

The third mixing step (S37) to the third supernatant removal step (S39) may be repeated as necessary.

Next, the washing step (S30) proceeds to a drying step (S40). The drying step (S40) is performed by drying the third precipitate layer under reduced pressure (reduced-pressure drying). The reduced-pressure drying is performed by heating, i.e., remaining at 50° C. for 72 hours under a reduced pressure atmosphere.

The washing step (S30) is completed as described above, and the metal nanowire catalyst 10 of the present embodiment is obtained.

Hereinafter, a result of actually producing a platinum nanowire catalyst as an example of the metal nanowire catalyst 10 and evaluating the platinum nanowire catalyst will be described.

### (Synthesis of Platinum Nanowires)

The metallic salt solution preparation step (S11) was performed by mixing 18.75 mmol of platinum (II) acetylacetonate (Pt(acac)₂), 22.5 mmol of glucose, 30 ml of 1-octadecene, and 45 ml of oleylamine with a stirrer. Thereafter, ultrasonic waves were applied to the metallic salt solution for 10 minutes to further perform stirring and mixing.

Next, as the catalyst-adding step (S12), 0.225 mmol of polyvinylpyrrolidone and 0.15 mmol of hexacarbonyl tungsten (W(CO)₆) were added to the metallic salt solution. Thereafter, as the heating treatment step (S13), the heating treatment was performed on the metallic salt solution. The heating treatment step (S13) was performed at 120° C. for 3 hours while the metallic salt solution was being stirred.

Next, the metallic salt solution that had been heated was subjected to the filtration step (S14) to collect platinum nanowires. Next, the separation step (S15) was performed. That is, a mixed solution of acetone, cyclohexane, and ethanol was added to the collected platinum nanowires. Thereafter, the suspension liquid containing the platinum nanowires was centrifuged, and the supernatant layer was removed, whereby the platinum nanowires were collected together with the precipitate layer.

Ethanol was added as a preservative solution to the precipitate layer obtained by the centrifugation, and ultrasonic waves were applied for 15 minutes. Through this step, a platinum nanowire dispersion liquid in which platinum nanowires were dispersed in ethanol was prepared. The platinum nanowire dispersion liquid thus prepared was transferred to a bottle and stored.

### (Supporting Step)

Next, the supporting step (S20) of supporting the synthesized platinum nanowires on the carbon supports 12 was performed. The carbon supports 12 were collected in 9630 mg, and a platinum nanowire dispersion liquid containing 107 mg of platinum nanowires, 200 ml of ethanol, 200 ml of cyclohexane, and 20 ml of oleylamine were added to the collected carbon supports 12 and mixed, thereby performing the support mixing step (S21).

Next, as the ultrasonic treatment step (S22), ultrasonic waves were applied to the mixed liquid prepared in the support mixing step (S21) by an ultrasonic homogenizer. The ultrasonic treatment step (S22) was performed for 60 minutes. Next, as the concentration step (S23), the mixed liquid subjected to the ultrasonic treatment step (S22) was centrifuged. Thereafter, the supernatant layer of the mixed solution was removed, and the supports were collected as the precipitate layer. Thereafter, as the drying step (S24), reduced-pressure drying was performed on the supports. Thereafter, as the baking step (S25), the supports was baked at 250° C. for 12 hours under an inert gas atmosphere containing a hydrogen gas at a concentration of 3%.

### Comparative Example 1

The metal nanowire catalyst 10 of Comparative Example 1 is supports obtained in the above-described baking step (S25).

### Comparative Example 2

The metal nanowire catalyst 10 of Comparative Example 2 was prepared by subjecting the supports obtained in the baking step (S25) to an additional baking treatment at 450° C. in order to remove organic substances.

### EXAMPLE

The metal nanowire catalyst 10 of Example was prepared by performing the following washing step on the supports obtained in the above-described baking step (S25). First, in the first mixing step (S31), 3.33 g of sodium borohydride and a first washing liquid were mixed to prepare a first mixture. The first washing liquid is a mixed liquid of 83 ml of water and 83 ml of ethanol. Next, 250 mg of the supports obtained in the baking step (S25) and 166 ml of the first washing liquid were put into a predetermined vessel and mixed. This operation caused bubbles from the supports. After generation of the bubbles from the support were stopped, centrifugation was performed as the first centrifugation step (S32), and the supernatant layer of the first mixture was removed as the first supernatant removal step (S33). The addition of the first washing liquid (first mixing step (S31)), the first centrifugation step (S32), and the first supernatant removal step (S33) were repeated five times. The first washing liquid was appropriately newly made and added.

Next, as the second mixing step (S34), the first precipitate layer was transferred to a 50-ml centrifuge tube, and 40 ml of pure water (ion-exchanged water) was added thereto, followed by mixing by manually shaking for 1 minute. Thereafter, the second centrifugation step (S35) and the second supernatant removal step (S36) were performed. The second mixing step (S34), the second centrifugation step (S35), and the second supernatant removal step (S36) were repeated three times.

Next, as the third mixing step (S37), 40 ml of acetone as the third washing liquid was added to the second precipitate layer, and mixing by manual shaking was performed for 1 minute. Thereafter, the third centrifugation step (S38) and the third supernatant removal step (S39) were performed. The third mixing step (S37), the third centrifugation step (S38), and the third supernatant removal step (S39) were repeated three times.

Thereafter, as the drying step (S40), reduced-pressure drying was performed on the suspension liquid of the third precipitate layer at 50° C. for 72 hours, and the metal nanowire catalyst 10 of Example was obtained.

Next, the metal nanowire catalyst 10 according to Comparative Example 1, Comparative Example 2, and Example were evaluated.

### (Evaluation Results by TG)

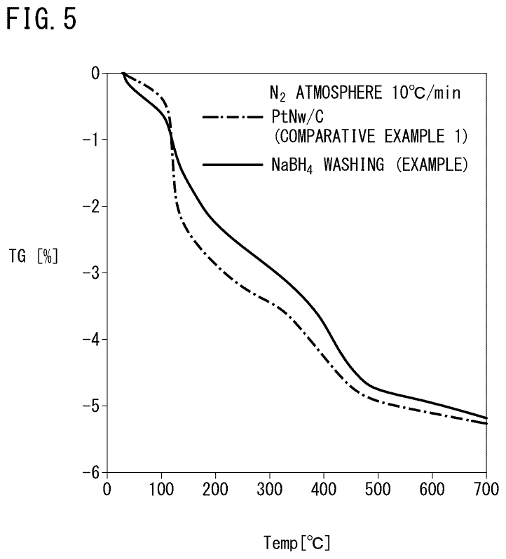

As shown in FIG. 5, the weight change of the metal nanowire catalyst 10 of Comparative Example 1 and the metal nanowire catalyst 10 of Example was measured by thermo-gravimetry (TG). The measurement was performed at a temperature ramp-up rate of 10° C./min under a nitrogen gas atmosphere. As shown in the figure, with increasing temperature, the impurities adhering to the metal nanowire catalyst 10 are volatilized and removed, and thus the weight is reduced. The results show that the weight change of the metal nanowire catalyst 10 of Example is smaller than the weight change of the metal nanowire catalyst 10 of Comparative Example 1 by about 0.3%. These results indicate that the impurity content is reduced in the metal nanowire catalyst 10 of Example subjected to the washing step (S30).

### (Observation by TEM)

Next, as shown in FIGS. 6A to 6C, the metal nanowire catalysts 10 of Comparative Example 1, Comparative Example 2, and Example were observed with a transmission electron microscope. As shown in FIG. 6A (Comparative Example 1) and FIG. 6C (Example), in the metal nanowire catalysts 10 of Comparative Example 1 and of Example, the carbon supports 12 and the platinum nanowires are dispersed, and a high surface area is maintained. In contrast, as shown in FIG. 6B, the carbon supports 12 and the platinum nanowires of the metal nanowire catalyst 10 of Comparative Example 2 undergo sintering due to the heat treatment at 450° C. In Comparative Example 2, the porosity of the carbon supports 12 is decreased, and the platinum nanowires are aggregated in a lump.

### (Atomic Concentration Measurement by XPS)

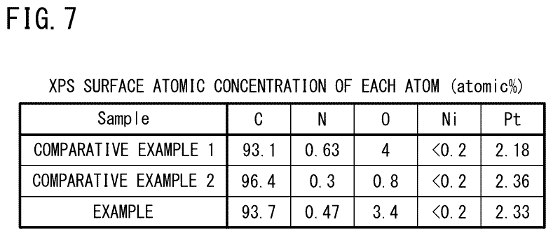

As shown in FIG. 7, the surface atomic concentrations of each of the metal nanowire catalysts 10 of Comparative Example 1, Comparative Example 2, and Example was measured by X-ray photoelectron spectroscopy. The atomic concentration of nitrogen comes from the dispersant and the protective agent (oleylamine). The atomic concentration of the oxygen reflects the reduction state of the surface of the platinum nanowires, and the lower the value of the concentration, the more the reduction proceeds, and the catalytic activity is improved. The atomic concentration of platinum indicates that more platinum nanowires are present on the surface of the metal nanowire catalyst 10.

The results show that the atomic concentrations of nitrogen and oxygen of the metal nanowire catalyst 10 of Comparative Example 1 not subjected to the washing step are higher than those of Comparative Example 2 and Example, and more impurities attach to the surface. In addition, the results show that in the metal nanowire catalyst 10 of Comparative Example 1, the amount of the platinum nanowires exposed on the surface is smaller than those of Comparative Example 2 and Example.

The results show that, in the case of the metal nanowire catalyst 10 of Comparative Example 2 (subjected to heat treatment at 450° C.), the atomic concentration of nitrogen derived from the dispersant and the protective agent decreases, and the remaining amount of impurities is the smallest. In addition, the results show that the atomic concentration of oxygen is the lowest, and that the reduction of the surface of the platinum nanowire has proceeded. Furthermore, the results show that the atomic concentration of platinum is the highest, and more platinum nanowires are exposed on the surface than in Comparative Example 1.

The results shown that, in the case of the metal nanowire catalyst 10 of Example, the atomic concentration of nitrogen is reduced as compared to Comparative Example 1, and the impurity concentration is reduced by the washing step. The results show that the atomic concentration of oxygen in the metal nanowire catalyst 10 of Example is lower than the atomic concentration of oxygen in Comparative Example 1, and the reduction of the surface of the platinum nanowire has proceeded. Furthermore, the results show that the atomic concentration of platinum in Example is increased as compared with Comparative Example 1, and more platinum nanowires are exposed on the surface.

### (Activity-to-Mass Ratio by RDE Method)

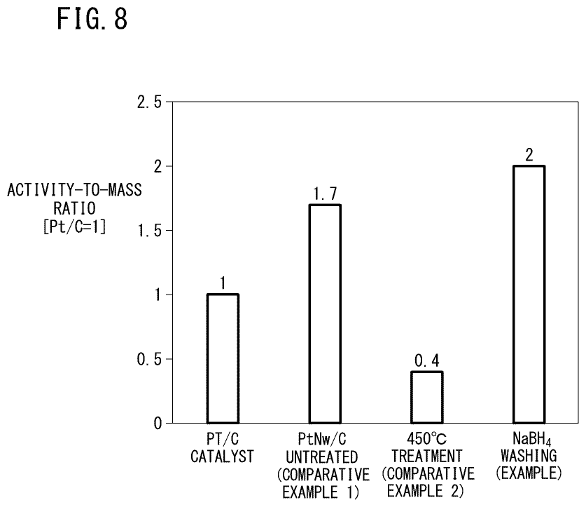

Next, as shown in FIG. 8, the activity-to-mass ratio was measured by a rotating disc electrode method (RDE method). Note that the Pt/C catalyst is a standard for comparison, and is a measurement result of a normal platinum catalyst in which platinum particles are supported on the carbon supports 12. The activity-to-mass ratio in FIG. 8 is a value (relative value) obtained by expressing the value of the catalytic activity per 1 g of platinum in the catalyst to be measured, as a ratio thereof to the catalytic activity per 1 g of platinum in the Pt/C catalyst. In this case, the activity-to-mass ratio of the Pt/C catalyst is 1.

The metal nanowire catalyst 10 of Comparative Example 1 has an activity-to-mass ratio of 1.7, and a higher catalytic activity is obtained than in the case of supporting platinum particles.

The results show that the metal nanowire catalyst 10 of Comparative Example 2 has an activity-to-mass ratio of 0.4, which is lower than that of the Pt/C catalyst. In the metal nanowire catalyst 10 of Comparative Example 2, it is considered that, although the impurity concentration decreases as shown in FIG. 7, the surface area decreases due to the sintering of the platinum nanowires as shown in FIG. 6B, and accordingly the catalyst activity decreases.

In contrast, the results show that the metal nanowire catalyst 10 according to Example has an activity-to-mass ratio that is twice that of the Pt/C catalyst, and the activity-to-mass ratio is improved compared to Comparative Example 1. In the metal nanowire catalyst 10 of Example, impurities are effectively removed by washing by using the hydride reducing agent. In addition, the metal nanowire catalyst 10 of Example prevents the occurrence of sintering. Furthermore, in the metal nanowire catalyst 10 of Example, the catalytic activity is improved by the surface of the platinum nanowire being reduced by the hydride reducing agent. As a result, the metal nanowire catalyst 10 according to Example has excellent catalytic activity.

The following Supplementary Notes are further disclosed in relation to the above embodiments.

### (Supplementary Note 1)

The method for producing the metal nanowire catalyst (10) according to the present disclosure includes: the supporting step (S20) of supporting the metal nanowires (14) on the carbon supports (12); and after the supporting step, the washing step (S30) of removing impurities from supports obtained by supporting the metal nanowires on the carbon supports. The washing step includes the first mixing step (S31) of bringing the solution containing the hydride reducing agent into contact with the supports; and the first separation step of removing the first impurities separated from the supports in the first mixing step, from the first mixture obtained in the first mixing step.

### (Supplementary Note 2)

In the method for producing the metal nanowire catalyst according to Supplementary Note 1, the first separation step may include the first centrifugation step (S32) of centrifuging the first mixture to separate the first mixture into the first precipitate layer containing the supports and the first supernatant layer containing the first impurities, and the first supernatant removal step (S33) of removing the first supernatant layer.

### (Supplementary Note 3)

In the method for producing the metal nanowire catalyst according to Supplementary Note 2, the washing step may further include: after the first separation step, the second mixing step (S34) of adding pure water to the first precipitate layer and mixing the pure water and the first precipitate layer; and the second separation step of removing the second impurities separated from the supports in the second mixing step, from the second mixture obtained in the second mixing step.

### (Supplementary Note 4)

In the method for producing the metal nanowire catalyst according to Supplementary Note 3, the second separation step may include the second centrifugation step (S35) of centrifuging the second mixture to separate the second mixture into the second precipitate layer containing the supports and the second supernatant layer containing the second impurities, and the second supernatant removal step (S36) of removing the second supernatant layer.

### (Supplementary Note 5)

In the method for producing the metal nanowire catalyst according to Supplementary Note 4, the washing step may further include: after the second separation step, the third mixing step (S37) of adding the organic solvent to the second precipitate layer and mixing the organic solvent and the second precipitate layer; and the third separation step of removing the third impurities separated from the supports in the third mixing step, from the third mixture obtained in the third mixing step.

### (Supplementary Note 6)

In the method for producing the metal nanowire catalyst according to Supplementary Note 5, the third separation step may include the third centrifugation step (S38) of centrifuging the third mixture to separate the third mixture into the third precipitate layer containing the supports and the third supernatant layer containing the third impurities, and the third supernatant removal step (S39) of removing the third supernatant layer.

### (Supplementary Note 7)

The method according to Supplementary Note 6 may further include the drying step (S40) of drying the third precipitate layer after the third separation step.

### (Supplementary Note 8)

In the method for producing the metal nanowire catalyst according to any one of Supplementary Notes 1 to 7, the hydride reducing agent includes at least one of sodium borohydride, lithium aluminum hydride, lithium borohydride, borane, sodium cyanoborohydride, or sodium triacetoxyborohydride.

### (Supplementary Note 9)

In the method for producing the metal nanowire catalyst according to any one of Supplementary Notes 5 to 7, the organic solvent includes at least one of acetone, toluene, xylene, methyl ethyl ketone, ethyl acetate, ethanol, methanol, acetic acid, or chloroform. These organic solvents can efficiently remove fat-soluble impurities from the metal nanowire catalyst.

Although the present disclosure has been described in detail, the present disclosure is not limited to the above-described embodiments. In these embodiments, various addition, replacement, changing, partial deletion, and the like can be made without departing from the essence and gist of the present disclosure or without departing from the essence and gist of the present disclosure derived from the contents described in the claims and equivalents thereof. These embodiments may also be implemented in combination. For example, in the above-described embodiments, the order of operations and the order of processes are shown as examples, and the present invention is not limited to them. The same applies to a case where numerical values or mathematical equations are used in the description of the above-described embodiments.

1. A method for producing a metal nanowire catalyst, the method comprising:
supporting a metal nanowire on a carbon support; and
after the supporting, washing a support obtained by supporting the metal nanowire on the carbon support, to remove impurities from the support, wherein the washing includes:
bringing a solution containing a hydride reducing agent into contact with the support; and
removing a first impurity separated from the support in the bringing, from a first mixture obtained in the bringing.

2. The method for producing the metal nanowire catalyst according to claim 1, wherein the removing of the first impurity includes:
centrifuging the first mixture to separate the first mixture into a first precipitate layer containing the support and a first supernatant layer containing the first impurity; and
removing the first supernatant layer.

3. The method for producing the metal nanowire catalyst according to claim 2, wherein the washing further includes:
after the removing of the first impurity,
adding pure water to the first precipitate layer and mixing the pure water and the first precipitate layer; and
removing a second impurity separated from the support in the adding of the pure water, from a second mixture obtained in the adding of the pure water.

4. The method for producing the metal nanowire catalyst according to claim 3, wherein the removing of the second impurity includes:
centrifuging the second mixture to separate the second mixture into a second precipitate layer containing the support and a second supernatant layer containing the second impurity; and
removing the second supernatant layer.

5. The method for producing the metal nanowire catalyst according to claim 4, wherein the washing further includes:
after the removing of the second impurity,
adding an organic solvent to the second precipitate layer and mixing the organic solvent and the second precipitate layer; and
removing a third impurity separated from the support in the adding of the organic solvent, from a third mixture obtained in the adding of the organic solvent.

6. The method for producing the metal nanowire catalyst according to claim 5, wherein the removing of the third impurity includes:
centrifuging the third mixture to separate the third mixture into a third precipitate layer containing the support and a third supernatant layer containing the third impurity; and
removing the third supernatant layer.

7. The method for producing the metal nanowire catalyst according to claim 6, further comprising drying the third precipitate layer after the removing of the third impurity.

8. The method for producing the metal nanowire catalyst according to claim 1, wherein the hydride reducing agent comprises at least one of sodium borohydride, lithium aluminum hydride, lithium borohydride, borane, sodium cyanoborohydride, or sodium triacetoxyborohydride.

9. The method for producing the metal nanowire catalyst according to claim 5, wherein the organic solvent comprises at least one of acetone, toluene, xylene, methyl ethyl ketone, ethyl acetate, ethanol, methanol, acetic acid, or chloroform.
